(19) United States
(12) Patent Application Publication
(10) Pub. No.: US 2007/0012203 A1
(43) Pub. Date: Jan. 18, 2007

(54) Method for coloring gray level laser engraved object

(76) Inventor: Kun-Cheng Lin, Taipei City (TW)

Correspondence Address: Kun-Cheng Lin, 235 Chung - Ho Box 8-24, Taipei, TW

(21) Appl. No.: 11/178,802

(22) Filed: Jul. 12, 2005

(51) Int. Cl. B41C 1/06

(52) U.S. Cl. 101/34

(57) ABSTRACT

A method for coloring an object engraved with gray level affect comprises steps of: storing an original draft of an image to be engraved as an image file, converting the image file into a gray level image; engraving an the object engrave according to the gray level image so that the object present a gray level effect; converting the image file into a modified color image; transferring the color image into a transfer paper to be as a colored transfer paper drawing; adhering the transfer paper on a surface of the object to be engraved; heating and pressing the object so that the dyes of the transfer paper are transferred to the object; removing the paper and transferring the object to an oven for heating so that the dyes on the object are fully combined with the object; and taking the object from the oven.

### FIELD OF THE INVENTION

The present invention relates to laser engraving, and particularly to a method for coloring an object engraved with gray level affect by a laser engraving device, wherein the laser engraving method is combined with heat transfer method so that the surface of the object presents a gray leveled and colored image.

### BACKGROUND OF THE INVENTION

In the conventional engraving or etching method, inks are covered on an object for engraving. However to coat the inks is difficult. Thereby the engraving tool is performed by machines or manually. The engraving images have no grave level effect.

However the laser engraving device is developed which has the effect of gray levels. In this technology, an image is scanned into a computer mainframe by a scanner or an image processing device. Then the laser engraving device engraves the object according to the gray level image so that the object has the gray level effect. However the gray level only presents single color effect and thus it cannot present color effect.

Furthermore, the prior art is only used to smooth object and can not be used to un-flat surface. Thereby in the prior art, if it is desired to have color effect, the color is added thereto manually. Obviously, it can not have an uniform quality and can not present a gradual change effect of colors. Thereby it is not suitable for mass product.

### SUMMARY OF THE INVENTION

Accordingly, the primary object of the present invention is to provide a method for coloring an object engraved with gray level affect by a laser engraving device, wherein the laser engraving method is combined with heat transfer method so that the surface of the object presents a gray leveled and colored image.

A further object of the present invention is to provide a method for coloring an object engraved with gray level affect by a laser engraving device, wherein when the present invention is applied to a transparent object. It will present a back light effect so as to reduce the cost in the prior art backlight printing plates.

(A) The process of laser engrave used in the present invention will be described herein.

An original draft of an image to be engraved is stored as am image file, wherein a film or a drawing with figures or textures is read by a scanner or an image processing device (such as a digital camera).

The image file is converted into a gray level image by an image process program, such as Photoshop in a computer, wherein a point data from the image is processed as gray level data. The data is converted and rearranged in a surface of an object to be engraved.

The object is engrave by a laser engraving device to have a vivid image.

The feature of the laser engrave is that the object is engraved to have a three dimensional effect with different gray levels so as to have the affect of single color photographs.

(B) The process of heat transfer of image is described herein.

The image file is converted into a modified color image (the color of the image is modified as desired) which has a ratio identical to the gray level image.

The color image is transferred to a transfer paper to be as a color drawing which can be outputted to a special laser color paper (or heat inject color paper) by a laser color printer (or a heat inject printer) as a color film.

(A) The process of the combination of laser engraving and heat transfer will be described herein.

The color film is adhered on the surface of the object to be engraved so that the color film is overlapped with the surface engraved according to the gray level image by the laser engraving device.

The object is placed in a platform of a heat press machine with predetermined temperature and time period (based on the films and the material of the object).

The color paper is removed and the object is transferred to an oven for heating (the temperature is determined by the object to be engraved) so that the color on the object is fully combined with the object.

The object is taken out from the oven, which is formed as a transparent full color laser engraved object.

The object is combined to a lamp decoration so that when the light is emitted from the lamp, the object on the lamp will present a very beautiful effect.

The various objects and advantages of the present invention will be more readily understood from the following detailed description when read in conjunction with the appended drawing.

### BRIEF DESCRIPTION OF THE DRAWINGS

FIG. 1 shows the flow diagram of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

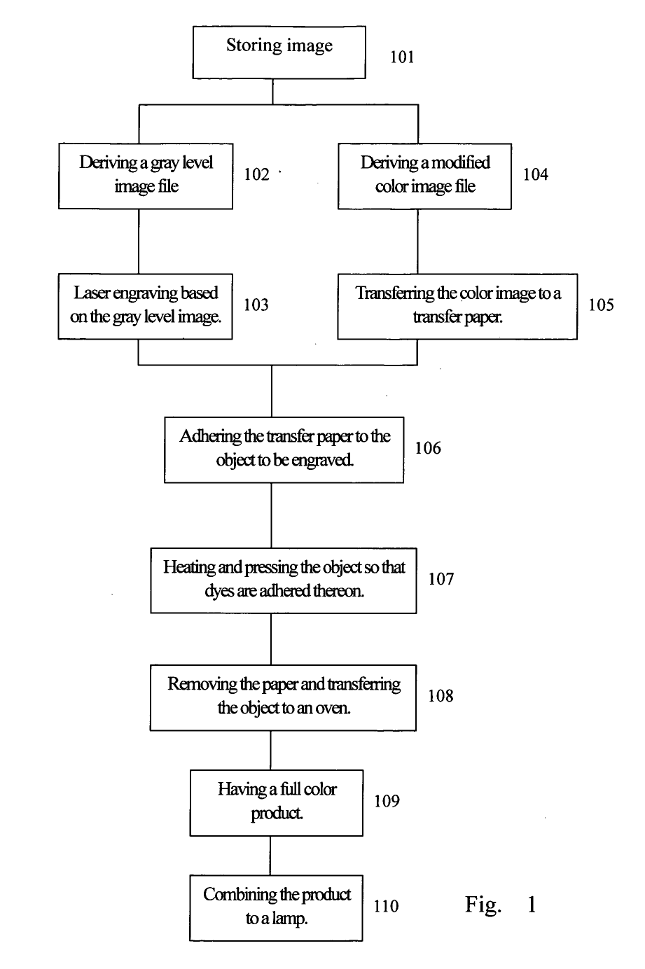

Referring to FIG. 1, the process of the present invention will be described herein.

In step 101, an original draft of an image to be engraved is stored as an image file, wherein a film or a drawing with figures or textures is read by a scanner or an image processing device (such as a digital camera).

In step 102, the image file is converted into a single color gray level image by an image process program, such as Photoshop program generally used in a computer, wherein pixel data from the image are processed as gray level data. The data are converted and rearranged in a surface of an object to be engraved.

In step 103, the object is engrave by a laser engraving device to have a vivid image.

In step 104, the image file is converted into a modified color image (the color of the image is modified as desired) which has a ratio identical to the gray level image.

In step 105, the color image is transferred to a transfer paper to be as a color drawing; wherein the color image is outputted to a special laser color paper (or heat inject color paper) by a laser color printer (or a heat inject printer) as a transfer paper with the color image.

In step 106, the transferring film is adhered on the surface of the object to be engraved so that the color film is overlapped with the surface of the object to be engraved according to the gray level image by using the laser engraving device.

In step 107, the object is placed in a platform of a heat press machine with predetermined temperature and time period (based on the films and the material of the object) to be heated so that the dyes of the colored transfer paper are adhered on the surface of the object to be engraved.

In step 108, the transferred paper is removed from the object and then the object is transferred to an oven for heating (the temperature is determined by the object to be engraved) so that the dyes on the object are fully combined with the object.

In step 109, the object is taken out from the oven, which is formed as a transparent full color laser engraved object.

In step 110 the object is combined to a lamp decoration so that when the light is emitted from the lamp, the object on the lamp will present a very beautiful effect.

An embodiment of the present invention will be described herein. Firstly, the image is scanned to a computer and the Photoshop program is actuated to read the scanned image (a film). The image is modified and then is transferred as a gray level image which is stored as a negative film with a file name of engraving file). The original transferred image is stored as a transferred file with a file name of transfer file (a negative file).

The COREL program (drawing operation program) is actuated and the engraving file is inputted into the COREL.

The laser engraving device is actuated and the engraving file is inputted into the device. An object to be engraved is placed in position. The power and speed of the device are set. In engraving, the engraving file must be projected into the object by a mirror image. After engraving, the object is taken out.

Next, the transfer file is inputted into the COREL, the transfer file is printed into a special transfer paper. The transfer paper is taken out for further use.

The heat press machine is actuated with settings of 100° C. through 80 seconds. After the temperature reaches to the setting value, the object is placed into the machine, and the surface to be engraved is faced upwards. The transfer paper is aligned to the surface being engraved. The machine is actuated to start the heat press action. After complete the action, the transfer paper is removed from the object and the object is placed into an oven with a temperature of 90° C. through 90 seconds. After temperature is reduced, the object is taken out.

The object is combined to a lamp decoration so that when the light is emitted from the lamp, the object on the lamp will present a very beautiful effect.

Thereby from above discussion, it is known that by the present invention, the gray leveled image can be colored so as to present various vivid images.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for coloring an object engraved with gray level affect by a laser engraving device comprising steps of:
storing an original draft of an image to be engraved as an image file,
converting the image file into a single color gray level image;
engraving an object according to the gray level image by a laser engraving device so that the object present a gray level effect;
converting the image file into a modified color image;
transferring the color image into a transfer paper with dyes on the transfer paper to present the color image;
adhering the transfer paper on a surface of the object to be engraved;
heating and pressing the object so that the dyes of the transfer paper are adhered on the object;
removing the transfer paper and transferring the object to an oven for heating so that the dyes on the object is fully combined with the object; and
taking the object from the oven.

2. The method for coloring an object engraved with gray level affect by a laser engraving device as claimed in claim 1, wherein the object is combined to a lamp decoration so that when the light is emitted from the lamp.

3. The method for coloring an object engraved with gray level affect by a laser engraving device as claimed in claim 1, wherein a film or a drawing with figures or textures is read by a scanner or an image processing device.

4. The method for coloring an object engraved with gray level affect by a laser engraving device as claimed in claim 1, wherein the image file is converted into a gray level image by an image process program; pix data from the image are processed as gray level data and the data are converted and rearranged in a surface of an object to be engraved.

5. The method for coloring an object engraved with gray level affect by a laser engraving device as claimed in claim 1, wherein a surface of the object to be engraved is engraved by a laser engraving device.

6. The method for coloring an object engraved with gray level affect by a laser engraving device as claimed in claim 1, wherein the color drawing is outputted to a special laser color paper or heat inject color paper by a laser color printer or a heat inject printer as a colored transfer paper.

7. The method for coloring an object engraved with gray level affect by a laser engraving device as claimed in claim 1, wherein the transfer paper is overlapped with the surface engraved according to the gray level image.

8. The method for coloring an object engraved with gray level affect by a laser engraving device as claimed in claim 1, wherein the object is placed in a platform of a heat press machine with predetermined temperatures and time period based on the films and the material of the object.

9. The method for coloring an object engraved with gray level affect by a laser engraving device as claimed in claim 1, wherein the temperature of the oven is adjusted according to the object to be heated so that the dyes of the colors are adhered to the object.

10. The method for coloring an object engraved with gray level affect by a laser engraving device as claimed in claim 1, wherein the object is a transparent object.
